(19) United States
(12) Patent Application Publication
(10) Pub. No.: US 2013/0088152 A1
(43) Pub. Date: Apr. 11, 2013

(54) DIMMING APPARATUS FOR SOLID STATE LIGHTING FIXTURES

(71) Applicant: DOUGLAS W. HAGEN, Fresno, CA (US)

(72) Inventor: DOUGLAS W. HAGEN, Fresno, CA (US)

(73) Assignee: B-K Lighting, Inc.

(21) Appl. No.: 13/436,503

(22) Filed: Mar. 30, 2012

Related U.S. Application Data
(60) Provisional application No. 61/470,398, filed on Mar. 31, 2011.

(51) Int. Cl. H05B 37/02

(52) U.S. Cl. CPC H05B 37/02
USPC 315/130; 315/294

(57) ABSTRACT

Improved lighting fixtures are described each of which having its own dimming or intensity control capability that allows for providing the desired lighting output or luminous flux, at each of the fixtures. This capability can be embodied in a dimming device at each fixture that can be manually or wirelessly operated. The present invention is particularly applicable to low voltage landscape or architectural lighting systems, and allows for customizing of the system to meet the particular application. The present invention also allows for tuning of the output for each fixture to compensate for variations in emission.

This application claims the benefit of U.S. Provisional Patent Application Ser. No. 61/470,398, filed on Mar. 31, 2011.

### BACKGROUND OF THE INVENTION

1. Field of the Invention

This invention relates to solid state light fixtures, some of which utilize light emitting diodes or light emitting diode packages as their light source.

2. Description of the Related Art

Light emitting diodes (LED or LEDs) are solid state devices that convert electric energy to light, and generally comprise one or more active layers of semiconductor material sandwiched between oppositely doped layers. When a bias is applied across the doped layers, holes and electrons are injected into the active layer where they recombine to generate light. Light is emitted from the active layer and from all surfaces of the LED.

Technological advances over the last decade or more have resulted in LEDs having a smaller footprint, greater luminous flux, increased emitting efficiency, and reduced cost. LEDs also have an increased operational lifetime compared to other emitters. For example, the operational lifetime of an LED can exceed 50,000 hours, while the operational lifetime of incandescent bulb is 800 to 1,000 hours. LEDs can also be more robust than other lights sources and can consume less power. For these and other reasons, LEDs are becoming more popular and are now being used in more and more applications that have traditionally been the realm of incandescent, fluorescent, halogen and other emitters (“conventional lights).

Conventional lights have been provided with dimming apparatus that allow for light emitted by the individual or groups of lighting systems to be dimmed by a single controller. For systems having multiple conventional lights, the dimming system can be provided in a circuit wherein the single dimmer is coupled to the multiple lights so that the intensity of the lights can be controlled in unison. This is often referred to in the lighting industry as “scene luminaire control.” That is, an individual dimmer controls multiple conventional lights. These types of dimming circuits can require, in addition to the dimmer itself, the inclusion of one or more additional wires or conductors that can carry a signal from the dimmer to the individual conventional lights.

Dimming circuits can also be used for dimming solid state lighting fixtures (e.g. LED based lighting fixtures). Like conventional dimming systems, solid state lighting systems can require one or more conductors to carry dimming control signals. These additional conductors can be included in conduits just as the conductors carrying the lighting drive signals.

Another important class of lighting fixtures comprises landscape or architectural lighting fixtures. These can be arranged in many different ways and can be arranged to illuminate plants or hardscape, or the different features of a building's architecture. Many landscape lighting systems are considered “low voltage”, and are driven by a low voltage signal converted from a conventional 120 VAC signal. These lighting systems typically do not carry extra conductors necessary for integrating multiple solid state lighting fixtures into a system controlled by a single dimming apparatus. Further, it can be cost prohibitive to include this extra conductor, which would require direct burial of this extra conductor between the different lighting fixtures.

Solid state lighting fixtures, and in particular landscape lighting fixtures, are provided from the supplier with a fixed luminous flux. This luminous flux is dependent upon the selection of operating voltage and current, the effect of which fixes the lumen output and wattage consumption. In lighting systems where there are locations where it is desirable to have greater or less lighting intensity, different lighting fixtures are needed. This can complicate the process of designing and supplying landscape lighting systems with the desired lighting effect. Furthermore, lighting fixtures provided with lighting output advertised to be the same, can vary slightly and the emission of some lighting fixtures can change over time, such as due to emission degradation of the solid state light sources as well as the increased luminous flux from the similar emitters over time due to efficiency gains incorporated into the LED design. There is typically no mechanism for dynamically adjusting the light output of the individual lighting fixtures to compensate for these changes so that the lighting fixtures emit what appears as the same lighting intensity.

### SUMMARY OF THE INVENTION

The present invention provides improved lighting fixtures each of which has its own dimming or intensity control capability that allows for providing the desired lighting output or luminous flux, at each of the fixtures. This dimming capability can be embodied in a dimming device at each fixture that can be manually or wirelessly operated. The present invention is particularly applicable to low voltage landscape or architectural lighting systems, and allows for customizing of the system to meet the particular application. The present invention also allows for tuning of the output for each fixture to compensate for variations in emission.

One embodiment of a light fixture according to the present invention comprises a fixture housing and a solid state light source mounted to the fixture housing. An emission intensity mechanism is also mounted to the light fixture and is operable to control the emission intensity of the solid state light sources. In some embodiments the intensity mechanism can comprise a potentiometer mounted to the housing. In still other embodiments, a plurality of secondary optics can be included, each of which is mounted over a respective one of the light sources to modify the light source emission pattern.

Still another embodiment of a light fixture according to the present invention also comprises a fixture housing. A light module is included that comprises a plurality of solid state light sources, with the light module removably mounted to the fixture housing. An optics module is also included that is removably mounted to the fixture housing and over the light module, with light from the solid state light source passing through the optics module. An emission intensity mechanism is included that is operable on the solid state light sources to control the emission intensity of the solid state light sources.

One embodiment of a lighting system according to the present invention comprises a plurality of light fixtures cooperating with one another to illuminate an object or location. At least one of the light fixtures comprises a fixture housing and a solid state light source mounted to the fixture housing. An emission intensity mechanism is mounted to the light fixture and is operable to control the emission intensity of the solid state light sources.

These and other aspects and advantages of the invention will become apparent from the following detailed description and the accompanying drawings which illustrate by way of example the features of the invention.

### BRIEF DESCRIPTION OF THE DRAWINGS

FIG. 1 shows a perspective view of one embodiment of a lighting fixture according to the present invention;

FIG. 2 shows a sectional perspective view of the lighting fixture shown in FIG. 2;

FIG. 3 shows a top view of one embodiment of a printed circuit board (PCB) assembly according to the present invention;

FIG. 4 is a side view of the PCB assembly shown in FIG. 3;

FIG. 5 is an exploded view of the PCB assembly shown in FIG. 3;

FIG. 6 is a schematic of one embodiment of an emitter driver circuit according to the present invention;

FIG. 7 is an exploded view of another embodiment of a lighting fixture according to the present invention;

FIG. 8 is a schematic of another embodiment of an emitter driver circuit according to the present invention; and

FIG. 9 is a schematic of another embodiment of an emitter driver circuit according to the present invention.

### DETAILED DESCRIPTION OF THE INVENTION

The present invention provides solid state lighting fixtures each of which has its own dimming control mechanism and circuitry. This allows for an enhanced level of lighting control in landscape lighting systems utilizing lighting fixtures according to the present invention. The present invention is particularly applicable to low voltage architectural and landscape lighting systems where it can be difficult to arrange a dimming circuit, though the invention would also be applicable to lighting systems that operate at line voltage. The output of each of the fixtures can be controlled to allow for tailoring output of the system to match its particular use.

In some embodiments the dimming control device can be included on a printed circuit board (PCB) that also has the solid state light source, with the PCB having conductive traces to interconnect the dimming device, light sources, and other fixture components. Many different dimming devices can be used according to the present invention, with some comprising a variable resistance device, such as a potentiometer. These types of dimming devices allow for nearly infinite control of the fixture output between the minimum and maximum levels. The fixtures can have many different minimum and maximum output levels, with some embodiments having minimum and maximums between 10% and 100% of maximum output.

Dimming arrangements provide for enhanced levels of control of lighting fixture output or light emission. This in turn allows for the same lighting fixture to provide many different levels of light output, which reduces or eliminates the need for supplying multiple different fixture types and models to satisfy different lighting outputs in a lighting system. The dimming arrangements also allow for “tuning” of the landscape system to match the lighting output of fixture having varying light output based on manufacturing differences.

In some embodiments the dimming device can be adjusted manually, such as by turning a control mechanism hand or by using a tool such as a screwdriver. In other embodiments, the dimming device can be controlled wirelessly, such as through a radio frequency (RF) controller. With conventional lights, the only way to reduce the lumen output of the fixture without a dimming circuit is to replace one lamp with another lamp of lower lumen output. The present invention provides lumen output adjustment without having a dimming circuit and without replacing the light source. The dimming device can be accessible from outside the lighting fixture, or can be accessible from inside the lighting fixture after removing a portion of the fixture, such as a lens, cap or cover. The dimming device can include a locking mechanism to hold the dimming device control in the desired location.

The present invention provides many advantages over conventional lighting fixtures. It can allow for dynamic lumen (i.e. output intensity) adjustment at individual fixtures, and does not require an external dimmer. The dimmer arrangement according to the present invention allows for emission at 100% of the fixtures available output maximum fixture down to a fraction of maximum (e.g. 10%). The dimmer arrangement can have a low end stop that helps keep the dimmer from flickering when its output is reduced. The lighting fixtures can be provided with a certain factory preset, such as the range of dimming, and the dimming control device (e.g. dial) can be marked for ease of use. The dimming arrangements can also be backwards compatible so that they can be used to retrofit existing non-dimming lighting fixtures.

The present invention is described herein with reference to certain embodiments, but it is understood that the invention can be embodied in many different forms and should not be construed as limited to the embodiments set forth herein. In particular, the present invention is described below in regards to certain light fixtures but it is understood that the present invention can be used with many different types of fixtures arranged in many different ways. The light fixtures are described herein utilizing light emitting diodes (LED or LEDs) or LED packages as their light source, but it is understood that other light fixtures according to the present invention can have many different types of light sources.

It is also understood that when an element or component is referred to as being “on” another element or component, it can be directly on the other element or intervening elements may also be present. Furthermore, relative terms such as “inner”, “outer”, “upper”, “above”, “lower”, “beneath”, and “below”, and similar terms, may be used herein to describe a relationship of one element of component to another. It is understood that these terms are intended to encompass different orientations of the device in addition to the orientation depicted in the figures.

Although the terms first, second, etc. may be used herein to describe various elements or components, these elements or components should not be limited by these terms. These terms are only used to distinguish one element or component from another. Thus, a first element discussed below could be termed a second element without departing from the teachings of the present invention. It is understood that actual systems or fixtures embodying the invention can be arranged in many different ways with many more features and elements beyond what is shown in the figures.

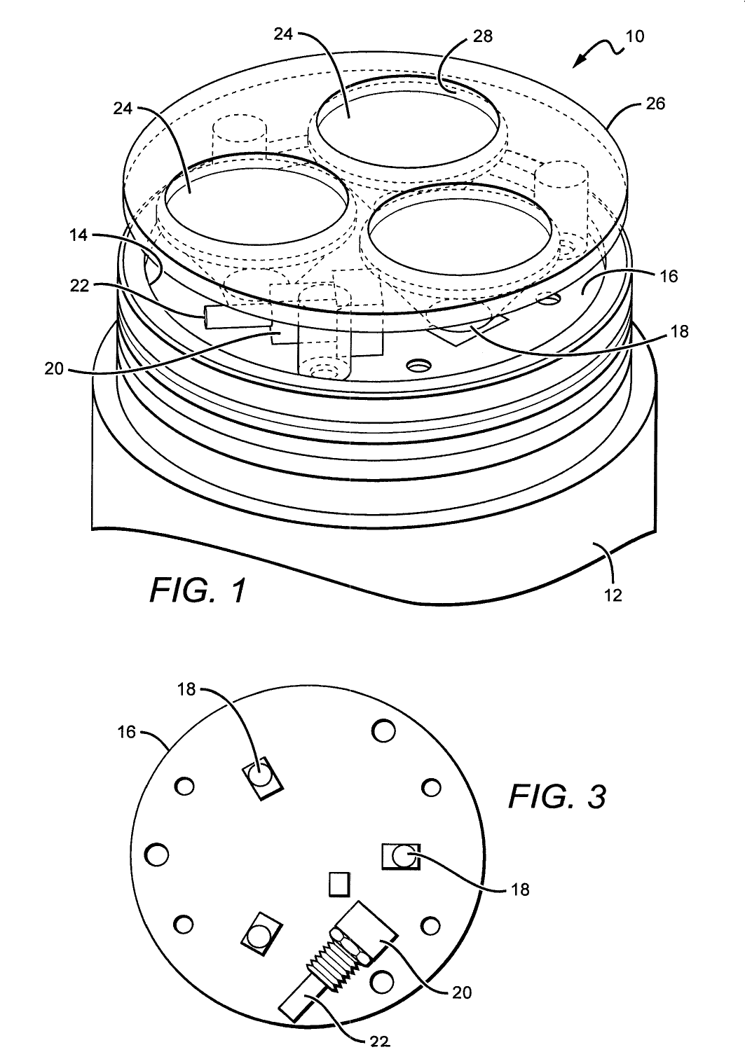

FIGS. 1 and 2 show one embodiment of a light fixture 10 according to the present invention comprising a cylindrical fixture housing 12. The light fixture 10 comprises a flood light, but it is understood that the present invention can be used with many other types of lighting fixtures, including but not limited to sign lighting fixtures, path lighting fixtures, architectural surface fixtures, architectural recessed fixtures, recessed ground fixtures. The housing 12 can be made of many different materials such as metals or plastics, and should be resistant to degradation from environmental conditions. In some embodiments that housing 12 can be made of a thermally conductive material that is in thermal contact with the fixture's heat generating elements, such as the power elements and the solid state light sources. In some embodiments the housing 12 can be coated with a material to help it resist environmental conditions. The housing 12 has a circular top opening 14 that is sized to hold a circular printed circuit board (PCB) 16.

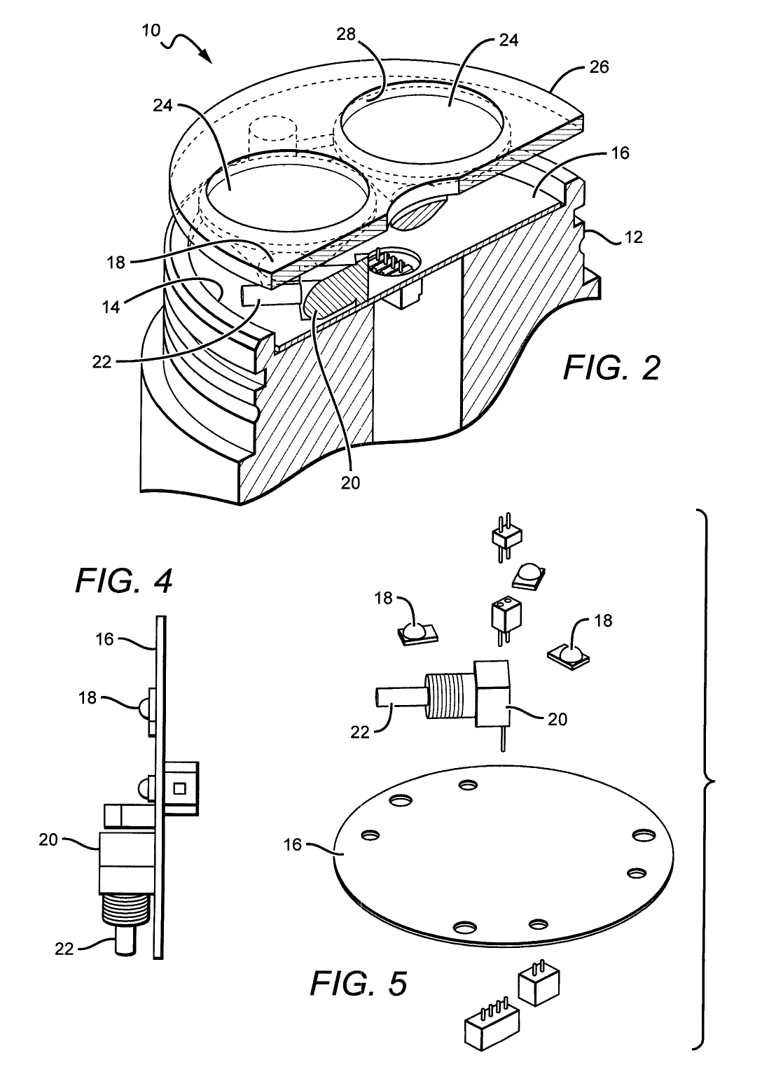

FIGS. 3 through 5 show one embodiment of a PCB 16 arranged according to the present invention, with light sources 18 mounted to the PCB 16. In the embodiment shown, the PCB 16 has three light sources 18, but it is understood that other embodiments can have fewer or more light sources. Light sources 18 can comprise LED packages commercially available from many different sources, with one embodiment having LED packages from Lumileds, Inc., available under the Rebel product name. The light sources can comprise many different LEDs or LED packages emitting the same or different colors of light with different color temperatures and different color rendering indexes. The include, but are not limited to white light with different color temperatures such as 2700K, 3000K or 4000K. In other embodiment the light sources can emit amber light for “turtle safe zones” and red, green or blue light for theatrical effect.

In still other embodiments, the fixture can have different LEDs or LED packages emitting different colors of light, with each being separately controllable. This can allow for the different LEDs to emit at different intensities, such that the fixture 10 can emit combinations of light from the LEDs that result in different fixture emission colors. This control of the overall fixture color emission can be provided at the same time as the control of the overall emission intensity according to the present invention.

The PCB 16 also comprises a mechanism 20 arranged according to the present invention to control the output intensity of the light sources 18. Many different mechanisms can be used according to the present invention, with one embodiment of the mechanism 20 comprising a potentiometer that can have a control dial 22 that can be hand turned, or turned using a tool such as a screwdriver. Turning the control dial varies the resistance provided by the potentiometer, with the varying resistance used by the fixture 10 to vary the emission intensity of the light sources 18. As mentioned above, the dimming device can also be changed wirelessly, such as by RF signals from known RF transmitters.

The PCB 16 can also comprise conductive traces (not shown) formed from electrically conductive materials such as metals with the conductive traces formed using known methods. The conductive traces are arranged to interconnect the components arranged on the PCB 16 such that the desired electrical signals can be transmitted between the two. Many different PCB types can be used such as standard FR-4 PCB, metal core PCB, or any other type of printed circuit board.

Referring again to FIGS. 1 and 2, the fixture 10 can be arranged with secondary optics 24, each of which can be over a respective one of the light sources 18. The secondary optics 24 can be arranged to direct the light from the light sources 18 into the desired fixture emission pattern. Different fixture emission patterns include, but are not limited to, wide flood, medium flood, spot and narrow spot emission patterns. Many different secondary optics can be used and in some embodiments should be made of a material that is substantially transparent to light from light sources 18. The secondary optics can be made of many different materials, such as silicone or glass, and can be formed using known methods. In still other embodiments, the fixture 10 can comprise reflectors to reflect light from the lights sources to the desired emission pattern. These reflectors can be arranged in many different locations and can comprise many different shapes and materials.

A cap 26 can also be included on the fixture 10, and in the embodiment shown the cap 26 can be made of an opaque material and can have openings 28 each of which are substantially aligned with the top of the secondary optics 24. This arrangement allows for the cap 26 to conceal and protect the internal components of the fixture 10, while at the same time allowing light from the light sources 18 to emit from the light fixture 10 through the openings 28. The cap can also be removable to allow access to the dimming device 20 to alter the emission intensity of the lamp.

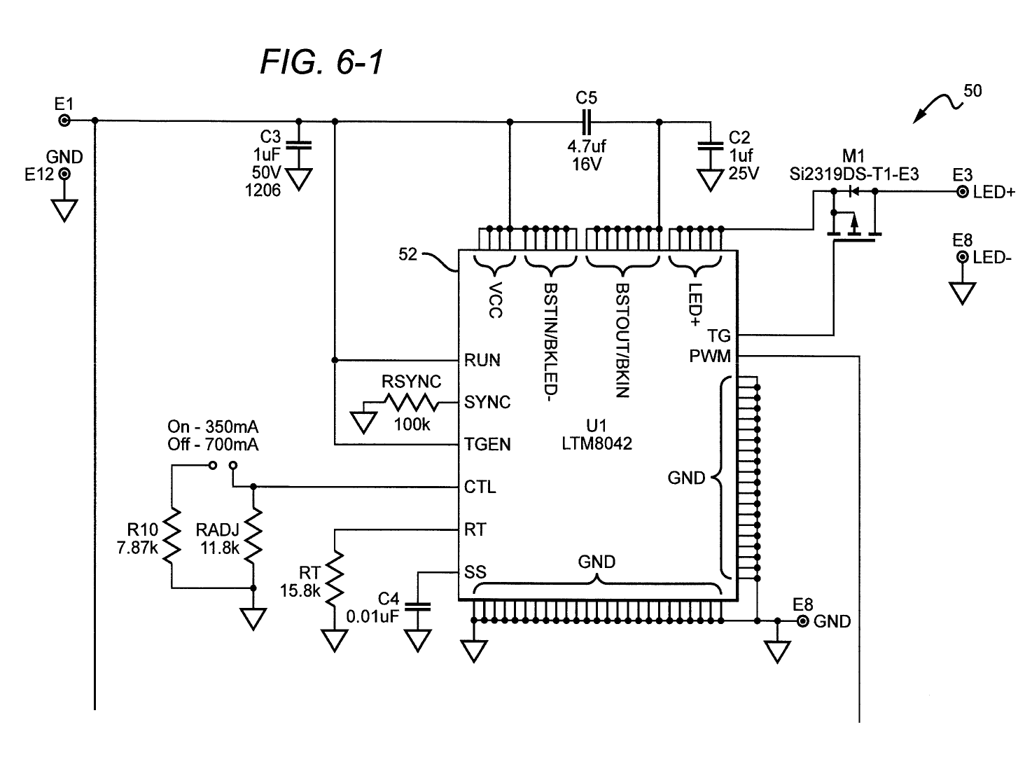

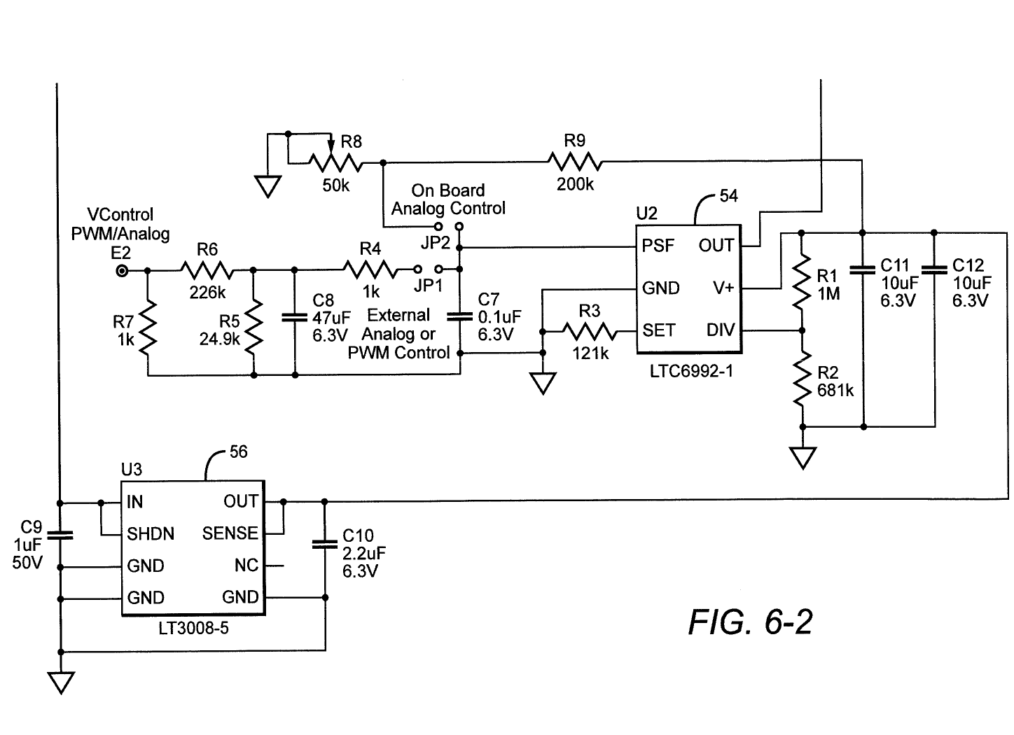

FIG. 6 shows one embodiment of driver circuit 50 arranged to drive the light sources in fixtures according to the present invention. The circuit 50 is arranged to accept the dimming signal from the dimming device as described above and change the drive signal to the light sources (or LEDs). The heart of the circuit 50 comprises the LED driver module 52 that provides the electrical signals to the fixtures light sources. In some embodiments that driver module can provide an electrical signal particularly applicable to driving LEDs or LED packages. Many different driver modules can be used that can be arranged in many different ways. Some commercially available driver modules can be used, with the embodiment shown utilizes the commercially available LTM8042 LED Driver and Current Source provided by Linear Technology. The driver module 52 accepts a pulse width modulated signal and generate drive signals that are coupled to LEDs or LED packages.

The circuit 50 also comprises a voltage controlled pulse width modulator 54 that accepts an analog signal and generates a pulse width modulated signal that is coupled to the driver module 52. In the embodiment shown, the modulator can accept a voltage generated from the potentiometer (i.e. On Board Analog Control) described above. The variable resistances provided by manipulating the potentiometer can be used to generate different voltages, and these different voltages can be used by the modulator 54 to generate different pulse width modulated signals. The modulator 54 can also accept a voltage signal from an external source identified in FIG. 6 as the External Analog or PWM Control. The modulator 54 can also utilize this external voltage to generate a pulse width modulated signal. Many different commercially available modulators can be used, with the embodiment shown using a LTC6992-1 Voltage Controlled Pulse Width Modulator from Linear Technology.

The circuit 50 can also comprise a voltage regulator that accepts input voltage of 15 to 19 volts and provides a stable output voltage. In the embodiment shown, the regulator 56 comprises a commercially available LT3008-Low Dropout Linear Regulator and accepts the input voltage and provides a 3.3 volt, 20 mA output signal that is coupled to the modulator 54. The circuit also comprises a number of discrete components such as resistors and capacitors, all of which are arranged in ways known in the art.

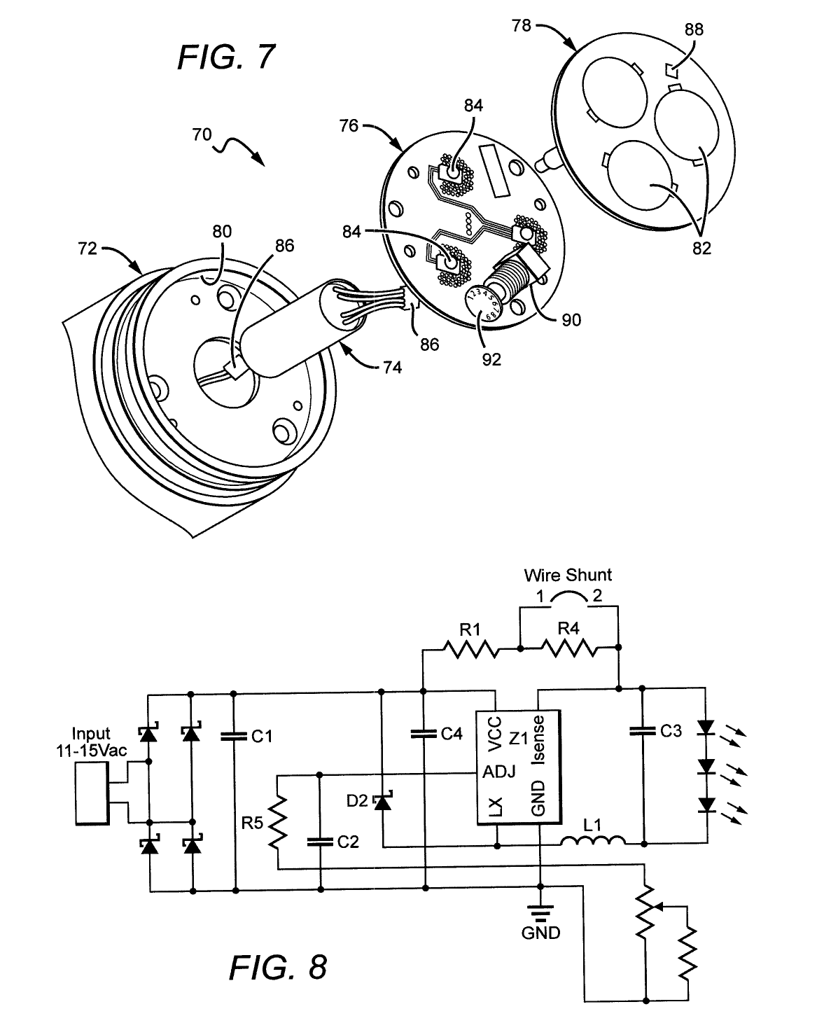

FIG. 7 shows another embodiment of a light fixture 70 according to the present invention comprising a fixture housing 72, and power driver 74, light module 76, and optics module 78. In this embodiment, the power driver 74, light module 76, and optics module 78 can be removably mounted to the housing 72, or other elements of fixture 70. This allows for easy upgrade, modification or repair of the fixture in the field. For example, a user could remove the light module 76 or optics module 78, to repair or replace one that has failed, or if a different emission color or pattern is desired. The desired light module 76 and optics module 78 can be mounted over the fixture opening 80 with a respective one of the secondary optics 82 in the optics module 78 over a respective one of the LEDs 84 on the light module 76. Similarly, the power module 74 can comprise quick disconnects 86 that allow for removal and replacement of the power module 74 in the field. In some embodiments of the fixture when fully assembled are hermetically sealed to protect the fixture's internal components from surrounding environment.

Many different power modules can be used in different embodiments according to the present invention, with the present power module 74 being a 12VAC driver compatible with standard low voltage lighting circuits. The light module 76 can comprise one or more LEDs 84 that can emit different colors of light with different characteristics as described above with reference to light fixture 10. The optics module 78 can comprise secondary optics that can be the same or different, and can provide the emission patterns described above.

The optics module 78 can also comprise an emission indicator 88 that easily identifies the beam angle for the emission patterns without having to open and/or disassemble the light fixture. In the embodiment shown, the indicator 88 is a color code, with the different colors corresponding to the different beam angles. In one embodiment blue can correspond to with flood, yellow to medium flood, green to spot and red to narrow spot. Other reference codes according to the present invention can use numbers, letters, symbols, etc., or combinations thereof.

The fixture 70 can also comprise a potentiometer 90 that can be mounted in many different locations in the fixture 70 and in different embodiments can be accessible by accessing the internal components of the fixture, or from outside of the fixture 70. The potentiometer 90 can have a dial or control that can be rotated as described above, to change the emission intensity of the fixture 70. In the embodiment shown, the potentiometer 90 can be rotated by hand or a tool, and in the embodiment shown comprises a series of intensity indicators 92, each of which corresponds to a different level of lumen intensity emission from the fixture 70. In the embodiment shown the intensity indicators comprise number 1 through 9. The numbers can take the fixture emission through different ranges of 0 to 100% of LED emission intensity, with the embodiment shown having an approximate emission intensity of 30% at one end of the number range, and 100% at the other end of the range. Other embodiments can have a range of approximately 10% to 100%, while others can have a range of approximately 20% to 100%. This is just a few examples of the different ranges of intensities that can be provided by the light fixtures according to the present invention. In some the potentiometer's dial or control can move freely through its range of motion, while in other embodiments it can comprise a series of notches or indents to stop at each of the particular numbers.

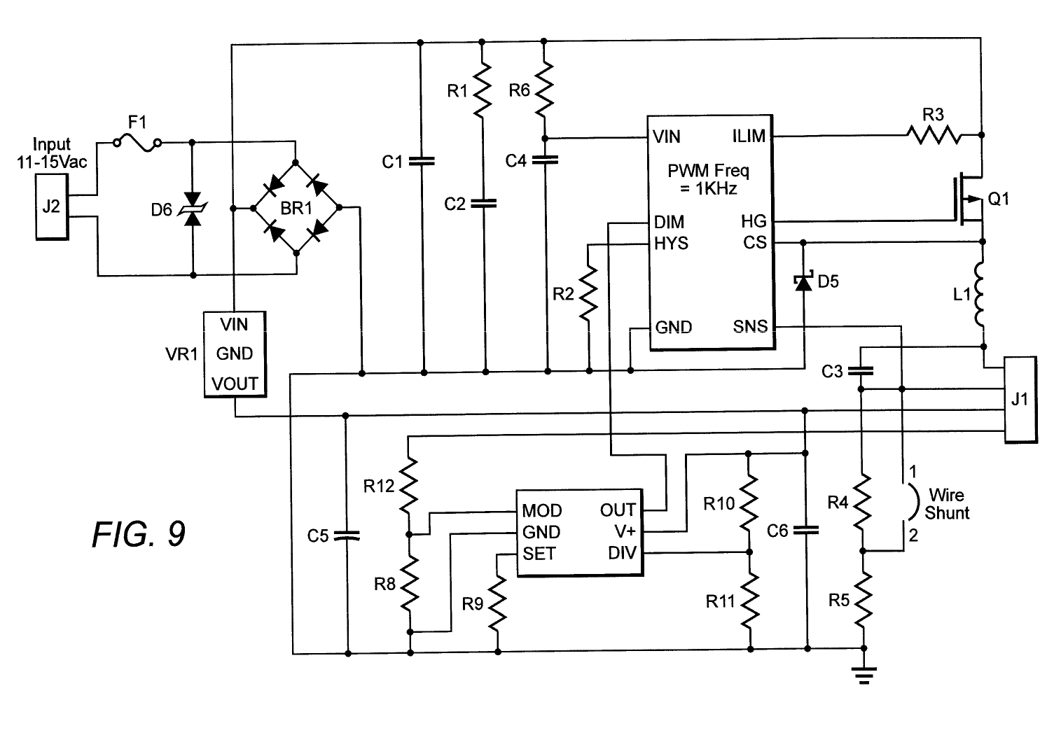

Other possible embodiments of driver circuits arranged to drive the light sources in fixtures according to the present invention are shown in FIGS. 8 and 9. FIG. 8 is arranged to change the drive signal to the light sources (or LEDs) via current control, such that the drive signal current varies with the dimming signal. FIG. 9 is arranged to change the drive signal to the light sources (or LEDs) via pulse-width modulation (PWM), such that the duty cycle of the pulse-width modulated drive signal varies with the dimming signal.

It is understood that the light fixture described above can be used in many different lighting systems having a plurality of lighting modules to illuminate and object, room or location. All, some or one of the lighting fixtures in these systems can be arranged with the features and characteristics of the embodiments described above.

Many alterations and modifications may be made by those having ordinary skill in the art, given the benefit of the present disclosure, without departing from the spirit and scope of the inventive subject matter. Therefore, it must be understood that the illustrated embodiments have been set forth only for the purposes of example, and that it should not be taken as limiting the inventive subject matter as defined by the following claims. Therefore, the spirit and scope of the invention should not be limited to the versions described above

I claim:

1. A light fixture, comprising:
a fixture housing;
a solid state light source mounted to said fixture housing; and
an emission intensity mechanism mounted to said light fixture and operable to control the emission intensity of said solid state light sources.

2. The light fixture of claim 1, wherein said intensity mechanism comprises a potentiometer.

3. The light fixture of claim 1, wherein said solid state light source comprises one or more light emitting diodes (LEDs).

4. The light fixture of claim 1, wherein said intensity mechanism is hand operable.

5. The light fixture of claim 1, wherein said intensity mechanism is wirelessly operable.

6. The light fixture of claim 1, wherein said solid state light sources are mounted on a removable printed circuit board.

7. The light fixture of claim 1, wherein further comprising one or more secondary optics, each of which is mounted over a respective one of said LEDs.

8. The light fixture of claim 1, being hermetically sealed.

9. A light fixture, comprising:
a fixture housing;
a plurality of light emitting diodes (LEDs) mounted to said fixture housing and providing and emission pattern from said housing;
a potentiometer mounted to said housing and operable to change the emission intensity of said LEDs; and
a plurality of secondary optics, each of which is mounted over a respective one of the LEDs to modify the emission pattern of its one of said LEDs.

10. The light fixture of claim 9, wherein said potentiometer is hand operable.

11. The light fixture of claim 9, wherein said potentiometer is wirelessly operable.

12. The light fixture of claim 9, wherein said solid state LEDs are mounted on a removable light module.

13. The light fixture of claim 9, wherein said potentiometer is capable of adjusting the emission intensity of the LED emission intensity in the range of 30% to 100% of maximum emission.

14. The light fixture of claim 9, wherein said potentiometer is capable of adjusting the emission intensity of the LED emission intensity in the range of 20% to 100% of maximum emission.

15. The light fixture of claim 9, wherein said potentiometer is capable of adjusting the emission intensity of the LED emission intensity in the range of 10% to 100% of maximum emission.

16. The light fixture of claim 9, wherein said secondary optics can modify the emission from said LEDs into one fixture emission pattern from the group comprising flood, medium flood, spot and narrow spot

17. The light fixture of claim 9, wherein said LEDs can emit light with a color temperature in the range of 2700 to 4000K.

18. The light fixture of claim 9, emitting light with different colors from the group comprising white, amber, red, green or blue.

19. The light fixture of claim 9, further comprising a visual indicator to show the type of fixture emission pattern.

20. A light fixture, comprising:
a fixture housing;
a light module comprising a plurality of solid state light sources, said light module removably mounted to said fixture housing;
an optics module removably mounted to said fixture housing and over said light module, with light from said solid state light source passing through said optics module; and
an emission intensity mechanism operable on said solid state light sources to control the emission intensity of said solid state light sources.

21. The light fixture of claim 20, wherein said intensity mechanism comprises a potentiometer mounted on said light module.

22. The light fixture of claim 20, wherein said optics module comprises a plurality of secondary optics, each of which is over a respective one of said solid state emitters.

23. The light fixture of claim 20, further comprising an indicator on said optics module showing the type of fixture emission pattern.

24. The light fixture of claim 20, further comprising a removable power supply.

25. A lighting system, comprising:
a plurality of light fixtures cooperating with one another to illuminate an object or location, at least one of said light sources comprising:
a fixture housing;
a solid state light source mounted to said fixture housing; and
an emission intensity mechanism mounted to said light fixture and operable to control the emission intensity of said solid state light sources.
